(19) United States
(12) Patent Application Publication
(10) Pub. No.: US 2016/0140619 A1
(43) Pub. Date: May 19, 2016

(54) MONITORING AND RESPONDING TO SOCIAL MEDIA POSTS WITH SOCIALLY RELEVANT COMPARISONS

(71) Applicant: Adobe Systems Incorporated, San Jose, CA (US)

(72) Inventors: Sachin Soni, New Delhi (IN); Walter Wei-Tuh Chang, San Jose, CA (US); Anmol Dhawan, Ghaziabad (IN); Ashish Duggal, New Delhi (IN)

(21) Appl. No.: 14/542,219

(22) Filed: Nov. 14, 2014

(51) Int. Cl. G06Q 30/02; G06Q 50/00; H04L 12/58

(52) U.S. Cl. CPC G06Q 30/0269; H04L 51/32; G06Q 50/01

(57) ABSTRACT

The present disclosure is directed toward systems and methods for leveraging social media. For example, systems and methods described herein involve monitoring social media posts and determining socially relevant competitors. Systems and methods described herein also involve identifying the features of the products that form a basis of comparison between the product and competitors. Systems and methods described herein may identify relevant social media discussions and reply to social media posts so as to influence the notions expressed therein.

### CROSS REFERENCE TO RELATED APPLICATIONS

N/A

### BACKGROUND

1. Technical Field

One or more embodiments relate generally to monitoring and responding to social media posts. More specifically, one or more embodiments relate to replying to social media posts with comparison data.

2. Background and Relevant Art

Social media is an increasingly popular means of facilitating discussions regarding a variety of topics. Discussion topics can range widely and include consumer products, businesses, entertainment, events, destinations, public figures, and so on. A social media user may post original messages, or may reply to messages posted by other social media users. Furthermore, in some cases, the social media user may also re-post a message posted by another social media user. In this way, social media users often engage in robust online discussions.

For example, a social media user may post a social media message asking for input from other social media users regarding a product. In another example, a social media user may post a social media message comparing two products based on a variety of features. Alternatively, a social media user may post a social media message disparaging one product based on certain product features while praising another product based on the same features. Indeed, more and more users look to social media to discover information about products and services. For instance, potential consumers will often seek advice on products via social media. Similarly, consumers often provide reviews or recommendations regarding products on social media. These types of social media discussions can influence a social media user regarding purchasing a product, attending an event, patronizing a business, traveling to a destination, and so on.

As such, these types of social media discussions present many opportunities for marketing. However, due to the explosive popularity of social media, accurately monitoring and leveraging social media manually is generally difficult and time consuming. For example, a marketer who monitors social media generally may not be able to effectively monitor all social media or effectively represent a company, product, service, etc. Due to the number of social media users as well as the volume of social media posts, it is often difficult for a social media monitor to identify and target social media users who are participating in relevant social media discussions. Similarly, it is generally difficult for the social media monitor to identify and respond to the relevant social media discussions.

Additionally, social media differs from many forms of traditional media. For example, often times social media users often have a much younger demographic and differing view points than users of traditional media (e.g., TV, newspaper, magazines). Many companies fail to appreciate the differences between traditional media and social media. Such companies often struggle to fully understand what social media users think of their products, how social media users compare their products to other products, and to which products social media users compare and contrast their products. Many companies simply have no efficient way to learn this information, and as such, lose out on learning valuable information available via social media.

Thus, there are several disadvantages to current methods for leveraging social media.

### SUMMARY

One or more embodiments described herein provide benefits and/or solve one or more of the foregoing or other problems in the art with systems and methods that allow marketers to effectively leverage social media. For example, systems and methods of one or more embodiments monitor social media posts that reference a keyword (product, service, brand, etc.) selected by a marketer. The systems and methods analyze social media posts including the keyword to identify themes or features being discussed in the social media posts. Once a theme or features is identified, the systems and methods identify whether the social media posts have a positive or negative sentiment toward the product, service, or brand. When social media posts with a negative sentiment are identified, the systems and methods can reply with a response based on one or more social media posts with a positive sentiment.

Optionally, the system and methods of one or more embodiments can monitor social media posts to identify socially-relevant competitors. In particular, the systems and methods can identify competitors by identifying entities mentioned, compared, or contrasted in social media posts to a brand, product or campaign. Additionally or alternatively, the marketer/campaign manager can provide a list of competitors or competing products.

In addition to identifying competitors, one or more embodiments can determine the social relevance of each competitor. For example, the systems and methods can determine which competitor's products are being compared or contrasted most often to an identified product by social media users. Furthermore, the systems and methods determine which features of an identified product are being discussed via social media. Along related lines, the systems and methods can identify how social media users view (e.g., favor or disfavor) an identified product or feature compared to socially-relevant competitors' products.

Furthermore, systems and methods of one or more embodiments may generate and provide real-time comparisons between a product and competitors' products. For example, the systems and methods may generate real-time comparisons based on information identified from one or more relevant social media posts. More specifically, one or more embodiments may track how social media users view or compare various features or products. The systems and methods can then utilize this comparison data to respond to a relevant social media posts. For example, in response to a social media post discussing a campaign product and a competing product, one or more embodiments may reply to the post with one or more posts from other social media users that include comparison information detailing the other social media users' views as to how the campaign product is better than the competing product.

Additional features and advantages will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a block diagram of an exemplary environment in which a social media marketing system in accordance with one or more embodiments can operate;

FIG. 2 illustrates a schematic diagram of the social media marketing system of FIG. 1 in accordance with one or more embodiments;

FIG. 3 illustrates a product comparison chart in accordance with one or more embodiments;

FIGS. 4A-4C illustrate an embodiment of the social media comparison system in accordance with one or more embodiments;

FIGS. 5A-5B illustrate an embodiment of the social media marketing system in accordance with one or more embodiments;

FIGS. 6A-6B illustrate an embodiment of the social media marketing system in accordance with one or more embodiments;

FIG. 7 illustrates a flowchart of a series of acts in a method of leveraging social media in accordance with one or more embodiments;

FIG. 8 illustrates a flowchart of a series of acts in a method of leveraging social media in accordance with one or more embodiments; and

FIG. 9 illustrates a block diagram of an exemplary computing device in accordance with one or more embodiments.

### DETAILED DESCRIPTION

One or more embodiments include a social media marketing system that allows marketers to effectively leverage social media. For example, the social media marketing system of one or more embodiments monitors social media posts that reference a keyword (product, service, brand, etc.) selected by a marketer. The social media marketing system can analyze social media posts including the keyword to identify themes or features being discussed in the social media posts. Once a theme or feature is identified, the social media marketing system can identify whether the social media posts have a positive or negative sentiment toward the product or brand. When social media posts with a negative sentiment are identified, the social media marketing system can reply with a response based on one or more social media posts with a positive sentiment.

For example, in one or more embodiments, the social media marketing system can repost social media posts with positive sentiments in response to social media posts with negative sentiments. In particular, the social media marketing system can identify relevant social media posts from other users that cast a product or features viewed negatively by a user in a positive light. One will appreciate in light of the disclosure herein, that responding to social media posts with social media posts from other users can carry more weight for users than responding with material directly from a marketing campaign.

Furthermore, the social media marketing system may generate and provide real-time comparisons between a product and competitors' products. For example, the social media marketing system may generate real-time comparisons based on information identified from one or more relevant social media posts. More specifically, the social media marketing system may track how social media users view or compare various features or products. The social media marketing system can then utilize this comparison data to respond to a relevant social media posts. For example, in response to a social media post discussing a campaign product and a competing product, the social media marketing system may reply to the post with one or more posts including comparison information detailing other social media users' views regarding how the campaign product is better than the competing product from the perspective of the other social media users.

Along related lines, one or more embodiments can generate a comparison chart based on the analyzed comparison data. For example, in one embodiment, the comparison chart may include socially relevant competitors, features of a product, and an indication of how social media users compare or rate the features of the product relative to related features of the competitors' products. Furthermore, the social media marketing system can update the comparison chart in real-time or substantial real-time. Thus, the social media marketing system can provide marketers with a real-time indication of how a product is fairing against socially-relevant competitors in the view of social media users.

Optionally, the social media marketing system of one or more embodiments can monitor social media posts to identify socially-relevant competitors. In particular, the social media marketing system can identify competitors by identifying entities mentioned, compared, or contrasted in social media posts to a brand, product or campaign. Additionally or alternatively, the marketer/campaign manager can provide a list of competitors or competing products.

In addition to identifying competitors, the social media marketing system can determine the social relevance of each competitor. For example, the social media marketing system can determine which competitor's products are being compared or contrasted most often to an identified product by social media users. Furthermore, the social media marketing system can determine which features of an identified product are being discussed via social media. Along related lines, the social media marketing system can identify how social media users view (e.g., favor or disfavor) an identified product or feature compared to socially-relevant competitors' products.

As used herein the term “social media system” refers to a system that supports or enables on-line communication, input, interaction, content-sharing, and collaboration between users. Example social media systems include TWITTER, FACEBOOK, PINTEREST, GOOGLE+, LINKEDIN, etc. The term “social media post” refers to content input or added to a social media system. Example social media posts include user comments, photos, videos, advertisements, sponsored posts, etc. Furthermore, social media posts can include acceptance or agreement of other social media posts such as “likes”, “retweets”, “pins”, etc.

As used herein the term “sentiment” refers to a view, attitude, or opinion regarding a topic. Sentiments can be positive, negative, or neutral. Furthermore, sentiments can have varying levels of positivity or neutrality. For example, a sentiment can be positive if it casts a product in a positive light. Additionally, a sentiment can be positive if it casts a competitor's product in a negative light. Along related lines, a sentiment can be negative if it casts a product in a negative light or casts a competitor's product in a positive light. Thus, responding to a social media post with a post with a positive sentiment can include responding with a post that casts a campaign product in a positive light or casts a competing product in a negative light.

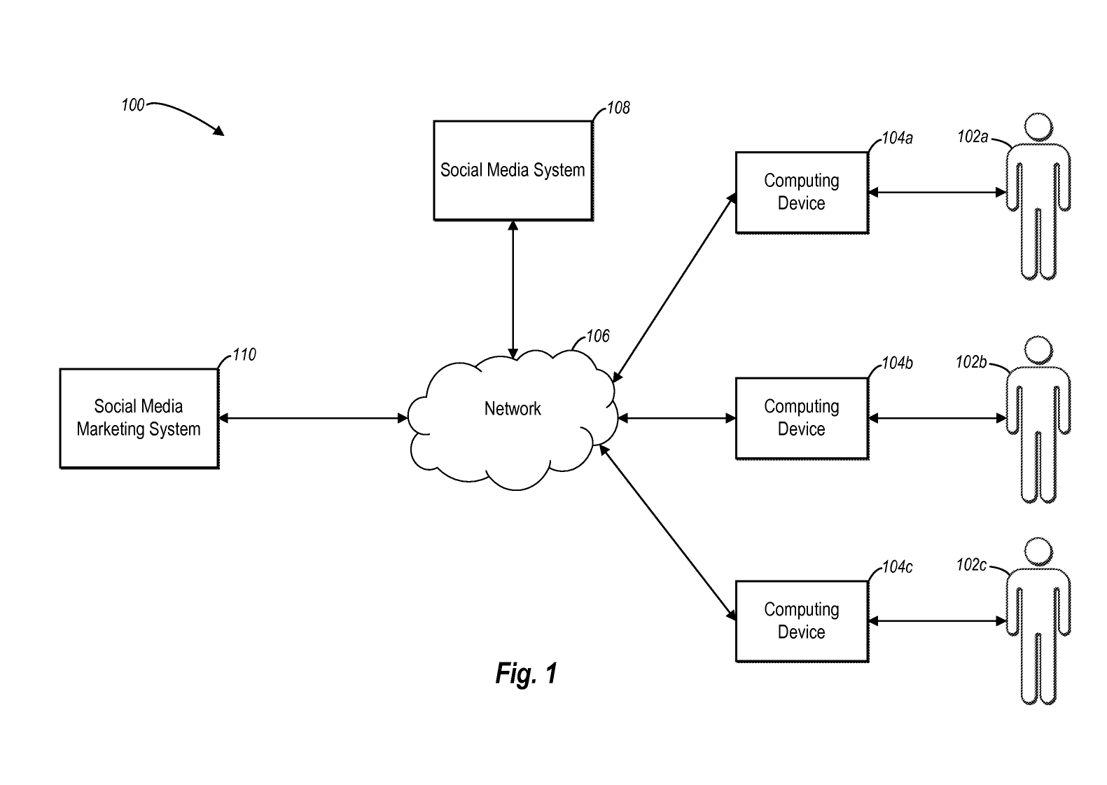

FIG. 1 is a schematic diagram illustrating a system 100 in accordance with one or more embodiments. As illustrated in FIG. 1, the system 100 can include users 102a, 102b, and 102c, client devices 104a, 104b, and 104c, and a network 106. The client devices 104a, 104b, 104c can communicate with a social media system 108 and the social media marketing system 110 through the network 106. Although FIG. 1 illustrates a particular arrangement of the users 102a, 102b, 102c, the computing devices 104a, 104b, 104c, the network 106, the social media system 108, and the social media marketing system 110, various additional arrangements are possible. For example, the computing devices 104a, 104b, 104c may directly communicate with the social media system 108, bypassing the network 106.

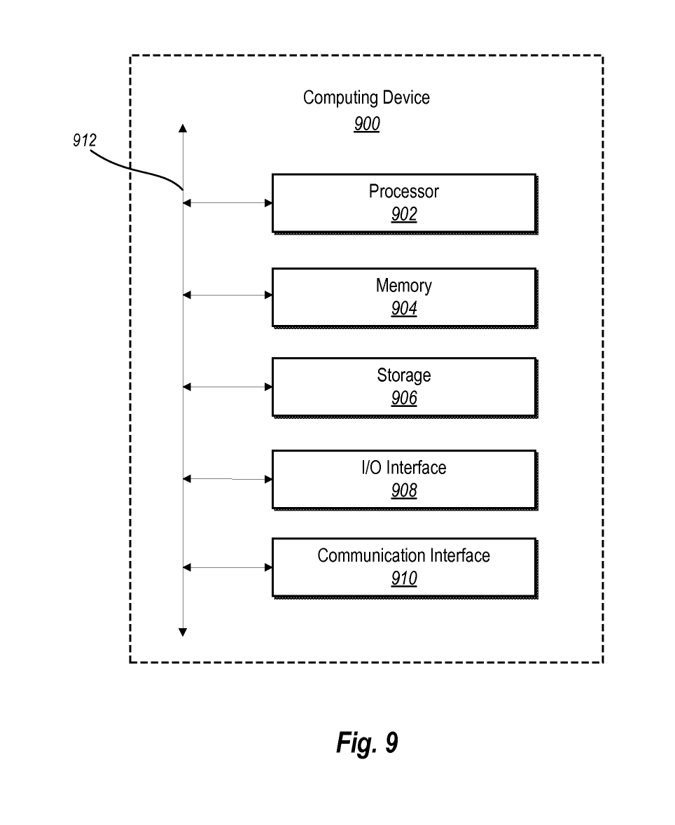

While FIG. 1 illustrates three users 102a, 102b, 102c, the system 100 can include more than three users. For example, the social media marketing system 110 may monitor, identify, and reply to social media discussions participated in by some or all of users 102a, 102b, 102c. Additionally, the social media marketing system 110 may also monitor, identify, and reply to social media discussions participated in by other users of the social media system 108. Furthermore, in one or more embodiments, the users 102a, 102b, and 102c can interact with the client devices 104a, 104b, and 104c, respectively. Examples of client devices include, but are not limited to, mobile devices (e.g., smartphones, tablets), laptops, desktops, or any other type of computing device, such as those described in relation to FIG. 9.

As mentioned, the client devices 104a, 104b, 104c can communicate with the social media system 108 through the network 106. In one or more embodiments, the network 106 may include the Internet or World Wide Web. The network 106, however, can include various other types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Example networks and network features are described below with reference to FIG. 9.

The client devices 104a, 104b, 104c of FIG. 1 can also send and receive social media posts by way of the social media system 108. For example, a social media application can run on each client device 104a, 104b, 104c, and thus be able to communicate with the social media system 108. The social media application can receive inputs from a user via a client device 104a (e.g., such as through a touch screen) to allow the user to input text, or other types of media, for use in social media posts. Thus, a user can send social media posts to social media applications of other users via the social media system 108.

The social media system 108 can post the social media posts (whether text or otherwise) to a social media graphical user interface (or “wall”) of one or more users of the social media system 108. For example, one or more embodiments may present the users 102a, 102b, 102c with a social media wall including social media posts from one or more co-users associated with the users 102a, 102b, 102c via the social media system 108. In one or more embodiments, each user 102 may scroll through their social media wall in order to view recent social media posts submitted by the one or more co-users associated with the users 102a, 102b, 102c via the social media system 108. In one embodiment, the system 100 may organize the social media posts chronologically on a user's social media wall. In alternative embodiments, the system 100 may organize the social media posts geographically, by interest groups, according to a relationship coefficient between the user and the co-user, etc. Additionally, in one or more embodiments, the users 102a, 102b, 102c may download a copy of their social media walls as a record of the social media posts.

Additionally, one or more embodiments allow the social media system 108 to transmit social media posts between the users 102a, 102b, and 102c. For example, in response to the user 102a submitting a social media post, the social media system 108 may update the social media wall of the users 102b and 102c to include the social media post submitted by the user 102a. In one embodiment, the social media system 108 may similarly transmit social media messages between two of the users 102a, 102b, 102c. In one or more embodiments, a social media message is a message between just two users, where a social media post is a post from one user for transmission to every co-user associated with the user via the social media system 108.

In one or more embodiments, the social media marketing system 110 may monitor, track, review, or otherwise “listen” to social media posts and/or messages sent amongst the users 102a, 102b, 102c via the social media system 108. For example, the social media marketing system 110 may monitor a social media post submitted by the user 102a. In some embodiments, the social media system 108 may provide access to the social media marketing system 110 prior to transmitting a submitted social media post or message to other users 102a, 102b, and 102c. Alternatively, the social media system 108 may transmit a submitted social media post to the social media marketing system 110 at the same time that the social media system 108 transmits the submitted social media post to the users 102a, 102b, and 102c. Additionally, in one embodiment, the social media system 108 may require the social media marketing system 110 to be associated as a co-user of the user 102a before the social media system 108 may allow access to the social media post by the social media marketing system 110.

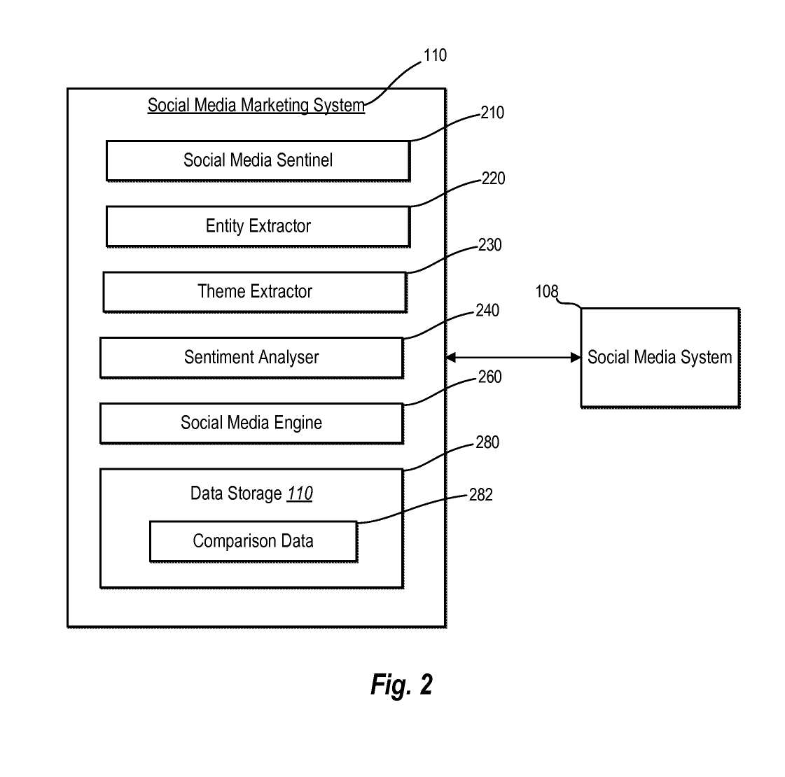

FIG. 2 illustrates a schematic diagram illustrating an example embodiment of the social media marketing system 110. As shown, the social media marketing system 110 may include, but is not limited to, a social media sentinel 210, an entity extractor 220, a theme extractor 230, a sentiment analyzer 240, a social media engine 260, and data storage 280. Each of the components 210-280 of the social media marketing system 110 may be in communication with one another using any suitable communication technologies. Although the disclosure herein shows the components 210-280 to be separate in FIG. 2, any of the components 210-280 may be combined into fewer components, such as into a single facility or module, or divided into more components as may serve one or more embodiments. In addition, the components 210-280 may be located on, or implemented by, one or more computing devices, such as those described below in relation to FIG. 9.

The components 210-280 can comprise software, hardware, or both. For example, the components 210-280 can comprise one or more instructions stored on a computer readable storage medium and executable by a processor of one or more computing devices. When executed by the one or more processors, the computer-executable instructions of the social media marketing system 110 can cause a computing device(s) to perform the methods described herein. Alternatively, the components 210-280 can comprise hardware, such as a special-purpose processing device to perform a certain function. Additionally or alternatively, the components 210-280 can comprise a combination of computer-executable instructions and hardware.

As mentioned above, and as shown in FIG. 2, the social media marketing system 110 can include a social media sentinel 210. The social media sentinel 210 can facilitate receiving and sending data to and from with the social media system 108. For example, the social media sentinel 210 may receive social media posts and messages submitted by the users 102a, 102b, 102c via the social media system 108. Additionally, the social media sentinel 210 may submit social media posts and messages to the social media system 108 for transmission to the users 102a, 102b, 102c from the social media marketing system 110.

Furthermore, in one or more embodiments, the social media sentinel 210 can package or format content items, in any necessary format, sent or received by the social media marketing system 110 via one or more communication channels using any appropriate communication protocol, as described below with reference to FIG. 9. For example, the social media system 108 may require data to be packaged in a particular manner before it can be transmitted as a social media post or message. In that case, the social media sentinel 210 may appropriately package data from the social media marketing system 110 as required by the social media system 108.

Additionally, the social media sentinel 210 can organize data received from the social media system 108. For example, the social media system 108 may transmit data to the social media marketing system 110 in the form of social media posts or messages. In one or more embodiments, and in response to receiving social media posts or messages, the social media sentinel 210 may organize the social media posts or messages according to one or more criteria. For instance, the social media sentinel 210 may organize the social media posts or messages chronologically, by sender, by groups of senders, by topic, etc.

In one or more embodiments, the set of social media posts captured by the social media sentinel 210 consists of all posts received via the social media system 108 over a period of time. For example, the social media sentinel 210 may capture a set of social media posts every sixty seconds. Additionally, in one or more embodiments, the social media sentinel 210 is configurable by a user. In that case, the user may configure the social media sentinel 210 to capture a set of social media posts at any interval of time. Alternatively, the set of social media posts captured by the social media sentinel 210 may be all posts received via the social media system 108 that mention a keyword, all posts received via the social media system 108 that mention another word configured by the user, or all posts received via the social media system 108 from a certain sender or co-user. Thus, the social media sentinel 210 may capture social media posts often enough that the comparison information generated by the social media marketing system 110 is almost completely up-to-date at all times.

As mentioned above, and as illustrated in FIG. 2, the social media marketing system 110 may further include an entity extractor 220. The entity extractor 200 extracts and compiles a list of socially relevant competitors of a product or brand submitted by a user of the social media marketing system 110. For example, a marketer may be interested in obtaining a list of socially relevant competitors related to “brand X.” Accordingly, the marketer can submit “brand X” to the social media marketing system 110 as a keyword. In response to the marketer submitting the keyword “brand X,” the entity extractor 220 can extract and compile a list of socially relevant competitors related to “brand X” based on social media posts monitored by the social media sentinel 210.

As used herein, a keyword is any term or phrase submitted by a user of the social media marketing system 110. In one or more embodiments, the keyword can be related to a product, a brand, a company, an event, a destination, or so on. By submitting a keyword to the social media marketing system 110, a user is indicating a product, brand, company, event, etc. that all comparison information generated by the social media marketing system 110 will be related to.

In one or more embodiments, the entity extractor 220 may extract and compile the list of social relevant competitors by analyzing a group of social media posts or messages received by the social media sentinel 210 via the social media system 108. For example, in an embodiment, the entity extractor 220 can identify social media posts or messages within a group of received social media posts or messages that mention or are related to the keyword. For instance, the entity extractor 220 may identify one or more social media posts or messages that include the text “brand X.” Alternatively, the entity extractor 220 may identify one or more social media posts or messages that include text related to a product or feature associated with “brand X,” or may identify pictures or photographs within the social media posts containing a logo or image associated with “brand X.” Additionally, the entity extractor 220 may identify one or more social media posts or messages that refer to “brand X” via a label, a hash tag, a check-in, a tag, etc.

Once the entity extractor 220 has identified one or more social media posts or messages that are related to a submitted keyword, the entity extractor 220 may also extract one or more entities from each of the identified social media posts or messages in order to determine a list of socially relevant competitors. For example, in one embodiment, the entity extractor 220 may utilize natural language processing to extract one or more entities from each of the identified social media posts or messages related to the keyword. The entity extractor 220 may extract entities including organizations, brands, products, people, organizations, cities, geographic features, etc. For example, a social media post can mention that brand Y is better than brand X. Based in this post, the entity extractor 220 can identify that brand Y is a competitor of brand X. Alternatively, the entity extractor 220 may extract one or more entities from each of the identified social media posts or messages based on a submitted list of known competitors.

Furthermore, the entity extractor 220 may also determine a type associated with the keyword and each of the extracted entities from the identified social media posts or messages. For example, the entity extractor 220 may determine a particular extracted entity is a socially relevant competitor of the keyword if both the keyword and the extracted entity have the same type. In one or more embodiments, the type of a keyword and/or an extracted entity is a thing (e.g., an automobile, an electronic device, a company), a place (e.g., a retail store, a sports area, a tourist destination), a person (e.g., a politician, an entertainer, a writer), an event (e.g., a concert, a fair, a play), and so on. If a type of an extracted entity may not be determined solely from the social media post, the entity extractor 220 may search a database (i.e., via the Internet) in order to determine the type of an entity. In one or more embodiments, once the entity extractor 220 determines that the keyword and an extracted entity have the same type, the entity extractor 220 can add the extracted entity to a list of competitors associated with the keyword. If the extracted entity already exists on the list of competitors, the entity extractor 220 may increment a count associated with the extracted entity, thus indicating that the extracted entity has been mentioned more than once in social media posts or messages associated with the keyword and is thus, a more relevant competitor in the list of competitors.

By way of example, the entity extractor 220 may receive an indication of the keyword “brand X” from a user as described above. In response to receiving the indication of the keyword “brand X”, the entity extractor 220 may identify one or more social media posts or messages received by the social media sentinel 210 that mention the keyword “brand X.” Next, the entity extractor 220 may extract one or more entities from the identified one or more social media posts or messages. For instance, if a social media posts received by the social media sentinel 210 includes the text, “I think brand X is so much better than brand Y,” the entity extractor 220 can recognize “brand X” as the keyword and “brand Y” as an entity.

Furthermore, in the same example, the entity extractor 220 may determine a type associated with both the keyword and each entity extracted from the identified one or more social media posts. For instance, the entity extractor 220 may determine the keyword, “brand X,” is of the type “automobile.” If the entity extractor 220 determines the extracted entity, “brand Y,” is also of the type “automobile,” the entity extractor 220 can add “brand Y” to a list of competitors associated with the keyword. If “brand Y” already exists on the list of competitors, the entity extractor 220 may increment a count associated with “brand Y” in the list of competitors, thus indicating the how socially relevant “brand Y” is as a competitor of “brand X.” If the entity extractor 220 determines that the type of the entity “brand Y” is not the same as the type of the keyword (i.e., “automobile”), the entity extractor 220 may disregard the entity “brand Y.”

As mentioned above, and as illustrated in FIG. 2, the social media marketing system 110 may further include a theme extractor 230. The theme extractor 230 utilizes the compiled list of competitors, as described above with reference to the entity extractor 220, in order to identify themes, features, and trends associated with a keyword. For example, if an entity has the type “automobile,” themes associated with that entity may include gas mileage, safety, interiors, resale value, etc. Thus, a user of the social media marketing system 110 may easily determine the themes, features, and trends that are being discussed in social media with reference to a company, product, event, person, location, etc.

In one or more embodiments, the theme extractor 230 begins the process for extracting themes by first identifying, for each of the competitors in the list of competitors discussed above, one or more social media posts and/or messages that reference both the submitted keyword and the competitor. Once the theme extractor 230 has identified one or more social media posts and/or messages including at least one competitor from the list of competitors and the keyword, the theme extractor 230 may then begin extracting themes by parsing the one or more social media posts and/or messages using natural language processing to identify parts of speech tags (e.g., nouns, verbs, adjectives, adverbs, etc.) and lexical chaining (in order to link related words together into phrases). Once the various parts of speech are identified, the theme extractor 230 may disregard any nouns that match the keyword and/or a competitor of the keyword.

In one or more embodiments, a theme is a noun phrase extracted from a social media post or message. For example, the theme extractor 230 may parse a social media post containing the text, “Brand X has a superior safety record compared to brand Y,” into nouns “brand X” and “brand Y,” as well as the noun phrase “safety record.” In one embodiment, the theme extractor 230 may disregard “brand X” and “brand Y” as matching the keyword and a competitor, respectively. Additionally, the theme extractor 230 may discard the word, “superior” as an adjective describing the noun phrase. Thus, by utilizing natural language processing, the theme extractor 230 has identified the theme of the social media post is “safety record.”

Natural language processing is a type of artificial intelligence that relies on grammars, syntaxes, and/or sets of rules in order to identify various language structures and parse text into various elements for analysis. For example, as mentioned above, the theme extractor 230 may utilize natural language processing to identify noun phrases in text that also references a keyword and a competitor. Additionally, the theme extractor 230 may further utilize natural language processing in order to determine whether the extracted noun phrase is of the same type as the keyword and the competitor. For example, if the keyword, “Brand X,” and the competitor, “Brand Y,” are both automotive companies, the theme extractor 230 may use natural language processing to determine whether the extracted noun phrase “safety record” is of a type that relates to automotive companies. The theme extractor 230 may do this by querying databases, performing web searches, applying rules, etc. in order to determine that automotive companies are often mentioned in connection with safety records. Thus, the theme extractor 230 may determine that “safety record” is an appropriate theme to extract from the social media post in relation to the keyword and the competitor.

It is possible that in one or more embodiments, the theme extractor 230 will not be able to extract a theme from a social media post. For example, a social media post may contain text solely directed at a keyword or a competitor (e.g., “I love Brand Y!” or “Brand Y is the worst!”). In that case, the social media marketing system 110 will not associate a theme with the social media post, but may continue analyzing the sentiments expressed in the social media post as described below.

As mentioned above, and as illustrated in FIG. 2, the social media marketing system 110 may further include a sentiment analyzer 240. The sentiment analyzer 240 identifies one or more sentiments associated with a social media post. In one or more embodiments, the social media marketing system 110 can base multiple determinations regarding the social relevancy of a social media post or message on whether the social media post or message is positively or negatively inclined toward the keyword based on one or more themes therein.

Additionally, the sentiment analyzer 240 may also store certain social media posts, such that the social media marketing system 110 may later use the stored social media posts in order to influence social media discussions. For example, in one or more embodiments, the social media marketing system 110 can utilize social media posts that are positively inclined toward the keyword to reply to social media posts that are negatively inclined toward the keyword. In one embodiment, the sentiment analyzer 240 can store positively inclined social media posts according to the themes mentioned therein and/or the competitors mentioned therein. Thus, in one embodiment, the social media marketing system 110 can persuasively reply to targeted social media discussions with the posts of other social media users, rather than with more traditional advertising tactics.

In one or more embodiments, the sentiment analyzer 240 can determine the sentiment of a social media post or message utilizing natural language processing. For example and as described above with regard to the theme extractor 230, the sentiment analyzer 240 can utilize natural language processing to parse a social media post utilizing natural language processing to identify parts of speech tags and lexical chains. Accordingly, the sentiment analyzer 240 can identify one or more adjectives and/or adverbs in a social media post or message that indicate a sentiment associated with the keyword, an entity, or a theme. Based on the identified one or more adjectives and/or adverbs, the sentiment analyzer 240 may assign a sentiment to the social media post or message.

For example, the sentiment analyzer 240 may utilize grammars, databases, web searches, or other rules in order to determine whether the identified one or more adjective and/or adverbs can be used to assign a sentiment to the social media post or message. In one or more embodiments, a sentiment is positive, negative, neutral, etc. Accordingly, in one example, the sentiment analyzer 240 may use standard dictionary-type lookups to determine that an adverb such as, “badly” is generally associated with a negative sentiment. Furthermore, the sentiment analyzer 240 may assign a weight to an identified sentiment, such that the identified sentiment may fall within a spectrum of sentiments (e.g., strongly positive, weakly negative, and so on). In one or more embodiments, the sentiment analyzer 240 can assign weights based on dictionary lookups, databases, rules, etc.

Additionally or alternatively, if a social media post or message has multiple phrases or sentences, the sentiment analyzer 240 may analyze sentiments at a phrase or sentence level, or may analyze sentiments across the full post or document. For example, a social media post may contain the text, “I love Brand Y! I just wish it wasn't so expensive.” Accordingly, this single post contains two phrases. In one or more embodiments, the sentiment analyzer 240 may analyze each phrase separately to determine a sentiment of each phrase (e.g., “I love Brand Y!” has a strong positive sentiment, “I just wish it wasn't so expensive” has a mildly negative sentiment). Alternatively, the sentiment analyzer 240 may analyze the post as a single document. In that case, the sentiment analyzer 240 may determine the post is associated with an overall weakly positive sentiment.

By way of example, another component of the social media marketing system 110 may pass a social media post to the sentiment analyzer 240 including the text, “Brand X has a superior safety record compared to brand Y.” The entity extractor 220 and theme extractor 230 may have already determined entities and themes within the social media post. In response to receiving the social media post, the sentiment analyzer 240 can utilize natural language processing to identify the adjective “superior” in relation to the keyword “brand X” and the theme “safety record.” Thus, in this example, the sentiment analyzer 240 may determine that the social media post including the text, “Brand X has a superior safety record compared to brand Y,” is positively inclined toward “brand X” with regard to safety records.

Furthermore, in an embodiment, the sentiment analyzer 240 may store social media posts that are positively inclined toward the keyword regarding a socially relevant theme, as discussed above. For example, in response to determining that a social media post is positively inclined toward the keyword with regard to a socially relevant theme, the sentiment analyzer 240 may direct the data storage 280 to store the social media post such that the social media post is associated with the socially relevant theme within the comparison data 282. In one or more embodiments, the social media marketing system 110 may later utilize the stored social media posts to influence social media discussions.

As mentioned above, and as illustrated in FIG. 2, the social media marketing system 110 may further include a social media engine 260. The social media engine 260 identifies relevant social media posts and messages, analyzes comparison data, builds comparison charts, and generates social media replies based on the comparison data. In some embodiments, the social media engine 260 may provide a user with a comprehensive analysis, via a comparison chart, indicating how the user's product is comparing to every other socially relevant competitor based on a variety of product features. In additional or alternative embodiments, the social media engine 260 may utilize relevant social media posts to generate social media replies to the identified social media posts so as to counteract or bolster a given sentiment within the identified social media posts.

In one or more embodiments, the social media engine 260 may analyze comparison data. For example, in one or more embodiments, the social media engine 260 may send a relevant social media post (i.e., a social media post associated with a keyword, as discussed above), to the entity extractor 220, the theme extractor 230, and the sentiment analyzer 240. In response to receiving data back from the entity extractor 220, the theme extractor 230, and the sentiment analyzer 240, the social media engine 260 can determine whether the post has a positive or negative sentiment, which entity the sentiment is directed toward, and which themes or entities the sentiment is directed.

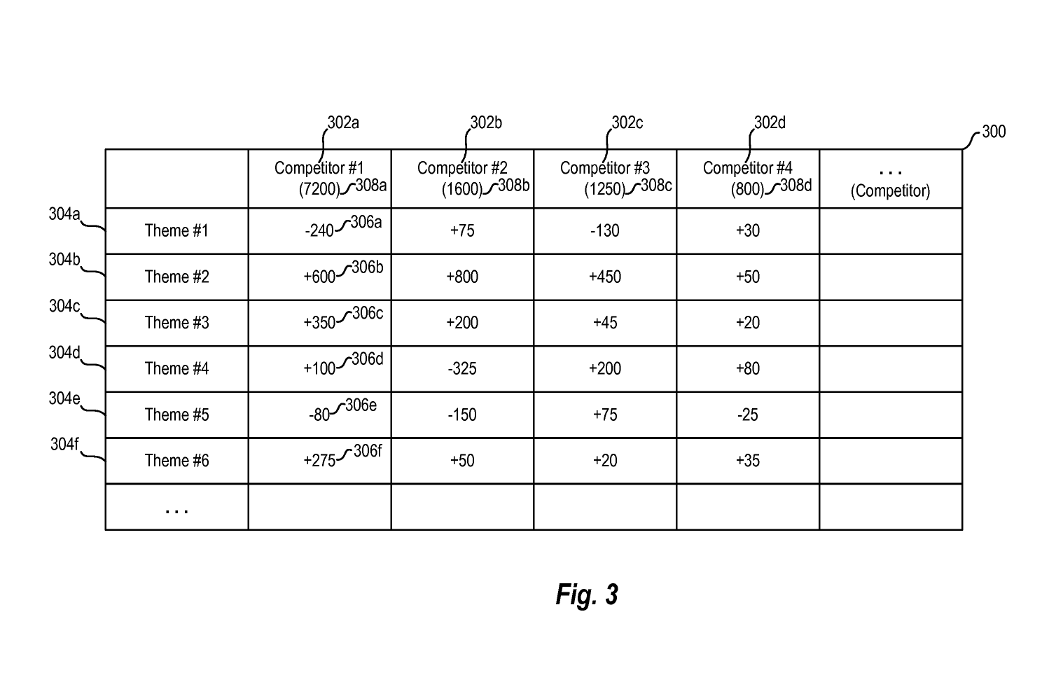

Furthermore, the social media engine 260 may build a comparison chart based on the analyzed comparison data. For example, in one embodiment, the comparison chart may provide information including socially relevant competitors associated with the keyword, a ranking of the socially relevant competitors, themes related to the keyword and each of the socially relevant competitors, and an indication as to how the keyword is doing against each of the socially relevant competitors with regard to each of the identified themes. Thus, for example, a user of the social media marketing system 110 may see at-a-glance how a product is fairing against its socially relevant competitors based on various features of the product. Construction of the comparison chart, as well as the lists of socially relevant competitors and themes, is further discussed below with regard to FIG. 3.

In one or more embodiments, the social media engine 260 may also identify relevant social media posts utilizing the list of socially relevant competitors described above with regard to the entity extractor 220. For example, the social media engine 260 may identify relevant social media posts by identifying posts and messages referencing both a keyword provided by a user, as well as each of the one or more competitors in the list of competitors, determined by the entity extractor 220 (e.g., “Should I buy brand X or brand Y?”). Additionally or alternatively, the social media engine 260 may identify relevant social media posts by identifying posts and messages where the only extracted entity is the keyword (e.g., “I love my product by brand X!”).

Additionally, in response to identifying a relevant social media post, the social media engine 260 may generate a reply to the relevant social media post so as to influence the user 102 who submitted the post. For example, the social media engine 260 may identify a relevant social media post including the statement, “Brand Y is so much safer than Brand X,” since the post includes the keyword, “Brand X,” and a socially relevant competitor, “Brand Y.” Next, as described above, the social media engine 260 may determine, via the theme extractor 230 and the sentiment analyzer 240, that the social media post is negatively inclined toward the keyword, “Brand X,” with regard to a socially relevant theme (i.e., safety).

In response to determining the relevant social media post is negatively inclined toward the keyword with regard to a socially relevant theme, the social media engine 260 may target the post and generate a reply in order to influence the social media discussion in favor of the keyword, “Brand X.” For example, as described above, the sentiment analyzer 240 may have stored one or more identified social media posts that are positively inclined toward the keyword with regard to the theme. Accordingly, in one or more embodiments, the social media engine 260 may search the comparison data 282 for social media posts associated with the theme, “safety.” The social media engine 260 may then generate a reply to the social media post negatively inclined toward the “safety” of “Brand X” that includes post(s) from other social media user that are positively inclined toward the “safety” of “Brand X.” Thus, the social media engine 260 may endeavor to counteract a negative sentiment with the positive sentiments of other users of the social media system 108.

Additionally or alternatively, the social media engine 260 may generate social media replies that include information related to the comparison chart, discussed above. For example, the social media engine 260 may generate a reply to a negatively inclined social media post that includes the completed comparison chart. Alternatively, the social media engine 260 may generate a reply to a negatively inclined social media post including a summary of information from the comparison chart that is relevant to a given theme. Furthermore, the social media engine 260 may generate a reply to negatively inclined social media post including a link to a webpage including the comparison chart, as well as other information related to the keyword.

Furthermore, the social media engine 260 may identify, target, and reply to social media posts that are positively inclined toward the keyword. For example, the social media engine 260 may identify and target a social media post including the message, “Brand X retains its resale value a lot longer than Brand Y.” In one or more embodiments, the social media engine 260 may generate a reply to this social media post intended to bolster the existing positive sentiment. For instance, the social media engine 260 may generate a reply that agrees with the statement and provides further information from the comparison table to support the statement (e.g., “Lots of other users agree with you! In the last 5 minutes 45 social media users have mentioned the high resale value of Brand X!”)

Additionally, the social media engine 260 may identify, target, and reply to social media posts that are negatively inclined toward one or more competitors of the keyword, as identified by the entity extractor 220. For example, using the processes described above, the social media engine 260 may identify a social media post that is negatively inclined toward a competitor of the keyword (e.g., “I am so disappointed in Brand Y's customer service”), even though the social media post does not mention the keyword. In one or more embodiments, the social media engine 260 can generate and automatically send a reply to this type of social media post including a positive sentiment toward the keyword (e.g., “Brand X is regularly recognized for its great customer service!”).

Although the social media engine 260 is mainly described herein as identifying, targeting, and replying to social media posts received from the social media system 108, in alternative embodiments, the social media engine 260 along with the other components 210-280 of the social media marketing system 110 can function in connection with other types of communication systems. For example, the social media marketing system 110 can operate in connection with a private communication system, such as, but not limited to a customer service message page associated with a website where users can post questions to a customer service representative via a real-time chat. In one embodiment, the private communication system may be associated with the keyword (e.g., a chat webpage associated with “Brand X”). Additionally or alternatively, the social media marketing system 110 may operate in connection with a private communication system associated with a competitor of the keyword (e.g., a chat webpage associated with “Brand Y”). Accordingly, in one embodiment, the social media marketing system 110 can maintain account information in order to log into one or more private communication systems.

As discussed above, the social media marketing system 110 can also include a data storage 280, as illustrated in FIG. 2. The data storage 280 may maintain comparison data 282 representative of data analyzed and generated by the social media marketing system 110. For example, the comparison data may include, but not limited to, keyword data, comparison analysis data, socially relevant competitor data, socially relevant theme data, socially relevant discussion data, and comparison chart data.

As mentioned above, the social media marketing system 110 can determine socially relevant competitors of a brand or product. Furthermore, the social media marketing system 110 can rank the relevance of each of the competitors based on how social media users compare or contrast a product with competing products. In other words, the social media marketing system 110 can determine how the various features of a product hold up in comparison to various competitors. In particular, the social media marketing system 110 may identify, categorize, and store social media posts and messages that are positively inclined toward the brand or product with regard to various themes related to a brand or product.

In one embodiment, the social media marketing system 110 can present the information described above to a marketer/campaign manager in the form of a comparison chart. For example, FIG. 3 illustrates one example of a comparison chart 300. As shown, the comparison chart 300 may include columns 302a-302d organized by competitor and rows 304a-304f organized by theme. Accordingly, cells indicate a relationship between each competitor and each theme in comparison to a product identified by a marketer. In particular, each cell can include a sentiment score 306a-306f. More specifically, a positive sentiment score can indicate that the count of social media posts discussing the feature that are positively inclined toward the identified product or negatively inclined toward a product of a given competitor are greater than the number of social media posts that are negatively inclined toward the identified product or positively inclined toward a product of a given competitor. Conversely, a negative sentiment score can indicate that the count or total number of social media posts discussing the feature that are negatively inclined toward the identified product or positively inclined toward a product of a given competitor are greater than the number of social media posts that are positively inclined toward the identified product or negatively inclined toward a product of a given competitor.

In one or more embodiments, the social media engine 260 may construct the comparison chart 300 by first compiling a list of socially relevant competitors. In order to compile a list of socially relevant competitors, the social media marketing system 110 may first receive a keyword from a user. In an embodiment, the keyword is a term associated with a brand or product. For example, if the user is a marketer for an automotive company, examples of a keyword include a brand name associated with the automotive company, a product sold by the automotive company, or any other term associated with the automotive company. In one or more embodiments, a user may provide the keyword. Alternatively, in other embodiments, the social media marketing system 110 can include pre-configured keywords.

Once the social media marketing system 110 receives the keyword, the social media sentinel 210 may capture a set of social media posts associated with the keyword. For example, in one or more embodiments, the social media sentinel 210 can receive social media posts submitted by the users 102a, 102b, 102c via the social media system 108. In an embodiment, the social media sentinel 210 may store the social media posts that are associated with the keyword as part of the comparison data 282 for later analysis by any of the components 220-260, described with reference to FIG. 2. The social media marketing system 110 can determine that a social media post is associated with the keyword if the social media post includes the keyword, includes a variation of the keyword, or is otherwise associated with the keyword.

In one or more embodiments, the social media marketing system 110 can capture all social media posts received via the social media system 108 over a period of time. For example, the social media sentinel 210 may capture a set of social media posts every sixty seconds. Additionally, in one or more embodiments, a user can configure the social media sentinel 210 to capture a set of social media posts at any interval of time. Alternatively, the social media sentinel 210 may capture all posts that mention the keyword, all posts received via the social media system 108 that mention another word configured by the user, or all posts received via the social media system 108 from a certain sender or co-user.

Once the social media sentinel 210 captures a set of social media posts associated with the keyword, the process for compiling a list of socially relevant competitors continues with the entity extractor 220 extracting a set of entities from each of the set of social media posts. As mentioned above, in one or more embodiments, an entity is a person, place, organization, brand, product, etc. For each entity extracted from a social media posts, the entity extractor 220 may determine whether the extracted entity is the same as or related to the keyword. For example, if the keyword is “brand X,” and the extracted entity is the same as the brand name, the entity extractor 220 can discard the extracted entity. Additionally or alternatively, the entity extractor 220 may determine an extracted entity is the same as the keyword if the extracted entity and the keyword are similar, or are otherwise associated.

If the entity extractor 220 determines the extracted entity and the keyword are not associated, the entity extractor 220 can determine if the extracted entity and the keyword are of the same type or category of products, brands, or services. For example, if the keyword is a car, the entity extractor 220 can determine if the extracted entity is car or a phone. If the extracted entity is a car or car maker, the entity extractor 220 can determine that the keyword and the extracted entity are of the same type (i.e., both automobiles). Alternatively, if the entity extractor 220 determines that the extracted entity is a type of cell phone, the entity extractor 220 can determine that the extracted entity (electronic device) is not the same type as the keyword (automobile).

If the extracted entity is of the same type, the entity extractor 220 can add the extracted entity to the compiled list of socially relevant competitors (i.e., create a new column in the comparison chart 300 for the entity). In one or more embodiments, the social media marketing system 110 assumes that entities mentioned in social media posts along with the designated keyword, and of the same type as the designated keyword, are socially relevant competitors. Thus, all extracted entities that are not the same as the keyword, but are of the same type as the keyword, are added to the compiled list of socially relevant competitors.

If an extracted entity already exists in the compiled list of socially relevant competitors, the entity extractor 220 may increment a count associated with the extracted entity. For example, if an extracted entity is “Competitor #1,” and “Competitor #1” already exists in the compiled list of socially relevant competitors, the entity extractor 220 can increment a count associated with the extracted entity. Thus, over time, the count associated with the most relevant competitor in the list of socially relevant competitors will be higher than other counts. In an embodiment, the entity extractor 220 can store the count associated with each competitor in the list of socially relevant competitors as a relevancy score indicating how relevant each competitor is in relation to the keyword.

In one or more embodiments, the social media engine 260 may organize the columns 302a-302d of the comparison chart 300 according to the relevancy of the competitors in the list of socially relevant competitors. For example, as shown in FIG. 3, “competitor #1” is the most relevant competitor as indicated by the relevancy score 308a associated with column 302a. The relevancy score 308a can indicate that, out of a set of social media posts identified over a period of time, a subset of seven thousand two hundred social media posts mentioned both the keyword and “competitor #1.” Accordingly, columns 302b, 302c, and 302d are arranged in descending order according to the relevancy scores 308b, 308c, and 308d.

Once the entity extractor 220 compiles the list of socially relevant competitors, the social media marketing system 110 may continue building the comparison chart 300 by identifying the socially relevant themes as indicated in rows 304a-304f. In one or more embodiments, in order to extract socially relevant themes mentioned in each social media post related to the keyword and at least one competitor, the social media sentinel 210 starts by capturing a set of social media posts associated with both the keyword and the first competitor in the list of socially relevant competitors. For example, the social media sentinel 210 may start by capturing social media posts that include the text of the keyword as well as the text, “Competitor #1.” Alternatively or additionally, the social media sentinel 210 may capture social media posts that are otherwise related to the keyword and “Competitor #1.”

Once the social media sentinel 210 has captured the social media posts associated with the keyword and “Competitor #1,” the social media sentinel 210 may next capture social media posts associated with the keyword and the second competitor in the list of socially relevant competitors. Thus, the social media sentinel 210 may eventually cycle through all the competitors in the list of socially relevant competitors. Accordingly, the social media sentinel 210 may eventually compile a set of social media posts, wherein each social media posts is associated with the keyword and at least one competitor from the list of socially relevant competitors. In some embodiments, a subset of social media posts captured by the social media sentinel 210 may include the keyword and more than one competitor from the list of socially relevant competitors.

Next, in order to determine themes associated with the rows 304a-304f in the comparison chart 300, the theme extractor 230 may extract a set of themes from each captured social media post. For example, as described above, for each captured social media post, the theme extractor 230 may identify one or more themes, features, or trends mentioned in the post. In one embodiment, the theme extractor 230 may compile a set of socially relevant themes. The set of socially relevant themes may indicate to a user the bases on which a product (i.e., the keyword) is being compared to its competitors. For example, if the user is marketing an automobile, the theme extractor 240 may compile a set of socially relevant themes from the captured social media posts that include themes such as “safety record,” “gas mileage,” “resale value,” etc. indicating the marketed automobile is being compared to its competitors based on these themes.

In one embodiment, the theme extractor 230 may extract a theme from a captured social media post that already exists in the set of socially relevant themes. In that case, the theme extractor 230 may increment a count associated with the extracted theme. Thus, once the theme extractor 230 has extracted sets of themes from each captured social media post, the counts associated with each theme in the compiled set of socially relevant themes may indicate how relevant each theme is in relation to current social media discussions.

The social media engine 260 may use each theme in the set of socially relevant themes to organize the rows 304a-304f of the comparison chart 300. For example, as shown in FIG. 3, rows 304a-304f are associated with theme #1-theme #6. In one or more embodiments, theme #1-theme #6 are the socially relevant themes extracted by the theme extractor 230. In one embodiment, the social media engine 260 may organize the rows 304a-304f such that the most socially relevant theme is associated with a top row 304a (based on a count associated with the theme, as described above), the next most socially relevant theme is associated with a second row 304b, and so on. Thus, in one embodiment, the cell associated with row 304a and column 302a includes a sentiment score that represents information related to the most socially relevant competitor (“Competitor #1”) and the most socially relevant theme (“Theme #1”).

For each theme extracted from each captured social media post, the sentiment analyzer 240 may additionally determine whether the captured social media post is positively, negatively, or neutrally inclined toward the keyword with regard to the theme. For example, once the theme extractor 230 extracts a theme from a captured social media post, the theme extractor 230 may pass the captured social media post to the sentiment analyzer 240. In one or more embodiments, the sentiment analyzer 240 may determine if the captured social media post is in favor of the keyword or in favor of the competitor with regard to the extracted theme. For example, if the captured social media post states, “Brand X has a superior safety record compared to brand Y,” the sentiment analyzer 240 may determine the social media post is in favor of “brand X” with regard to safety records.

If the sentiment analyzer 240 determines that a social media post is in favor of the keyword, the sentiment analyzer 240 may positively increment a count associated with the socially relevant competitor and the extracted theme that formed the basis of comparison between the keyword and the competitor associated with the post. For example, as shown in FIG. 3, the sentiment score 306b of the comparison chart 300 can represent that a sum of social media posts comparing the keyword and competitor #1 (of the column 302a) equals 600 posts in favor of the keyword.

If the sentiment analyzer 240 determines that a social media post is not in favor of the keyword (i.e., the post is in favor of the competitor), the sentiment analyzer 240 may decrement a count associated with the competitor and the theme forming the basis of comparison between the keyword and the competitor in the post. For example, as shown in FIG. 3, the sentiment score 306a of the comparison chart 300 can represent that a sum of social media posts is two hundred and forty social media posts in favor of competitor #1 based on theme #1 (of the row 304a). In one or more embodiments, the sentiment analyzer 240 may store the counts associated with the various competitors and themes as part of the comparison data 282.

In one or more embodiments, the process of incrementing and decrementing counts/sentiment scores may continue for each theme in the set of socially relevant themes. Thus, as illustrated in FIG. 3, the social media engine 260 can construct the comparison chart 300 to include numbers indicating whether the keyword is being compared favorably against competitor #1-competitor #4 (in columns 302a-302d) based on theme #1-theme #6 (in rows 304a-304f). Accordingly, a user may quickly determine the themes where the keyword compares most favorably or least favorably against its competitors. For example, as shown in FIG. 3, the keyword may compare slightly less favorably than competitor #1 based on theme #5, as indicated by the negative eighty for the sentiment score 306e. Similarly, the keyword may be strongly favored against competitor #1 based on theme #2, as indicated by the positive six hundred sentiment score 306b.

It will be understood that while the comparison chart 300 illustrated in FIG. 3 contains comparison information for only competitor #1-competitor #4 and theme #1-theme #6. In other embodiments, the comparison chart 300 may contain more or less information for more or less competitors and themes. For example, it is possible that social media posts may not compare certain competitors against the keyword with regard to certain themes. In that case, the social media engine 260 may leave a cell associated with the competitor and the theme blank.

In addition to the foregoing, the social media engine 260 may enhance the comparison chart 300 by providing an information summary, by providing color-coding, and/or by providing an informational key. For example, the information summary may include the identity of most socially relevant competitor, the most socially relevant theme, and an overall analysis indicating whether the keyword is generally more favored than competitors.

In one or more embodiments, the cells of the comparison chart 300 can provide access to the social media posts that are the basis of the sentiment score. For example, each cell can include a hyperlink to the social media posts that form the basis of the sentiment scores 306a-306f. In one or more embodiments, the social media marketing system 110 can only maintain and provide the positively inclined posts.

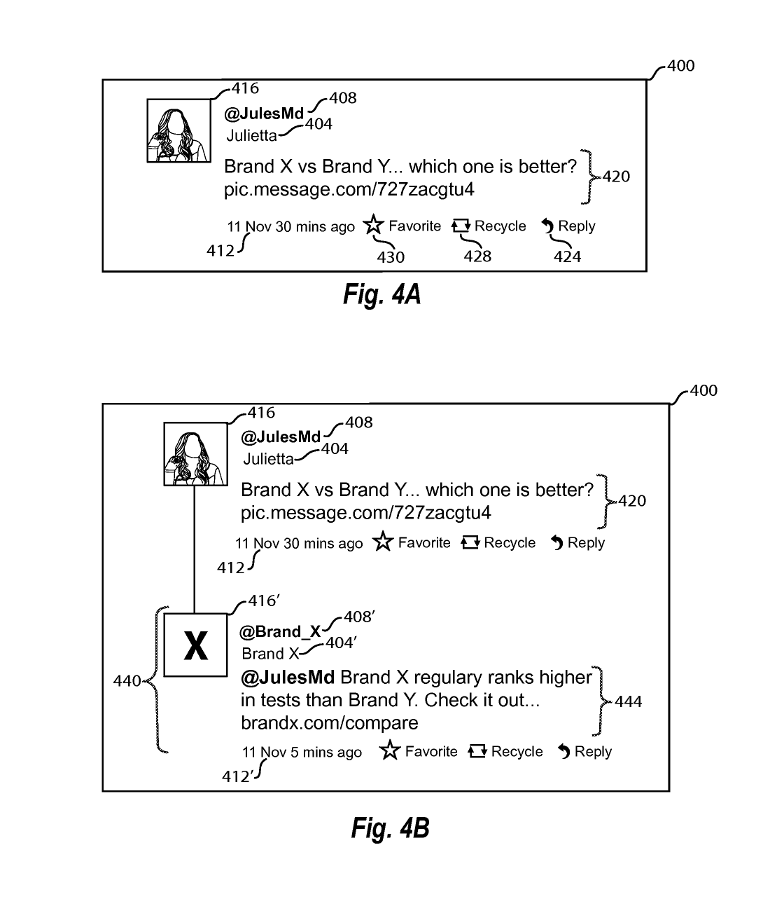

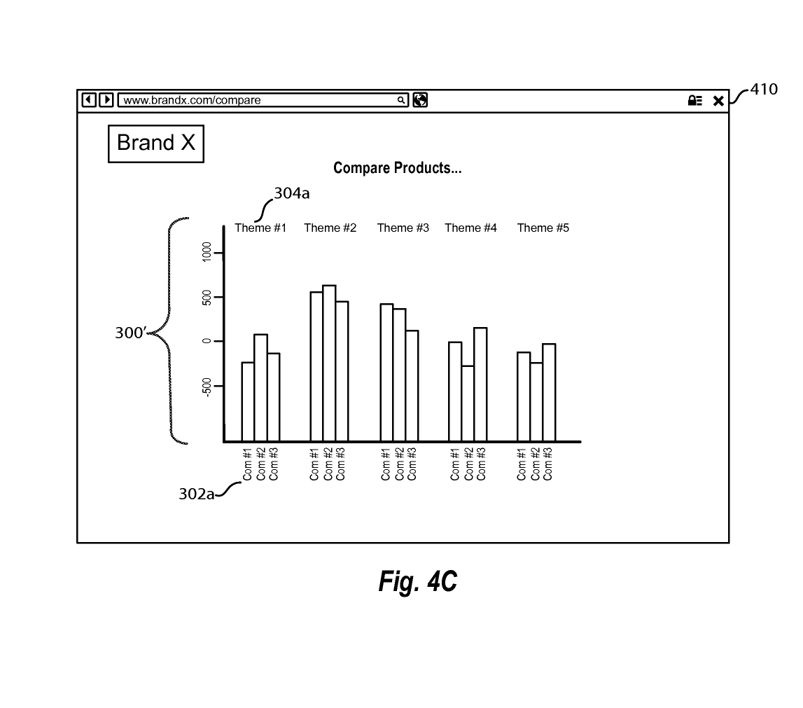

One will appreciate in light of the disclosure herein that the format of the comparison chart 300 of FIG. 3 is only one example format. In alternative embodiments, the social media marketing system 100 can provide the same or similar information provided by the comparison chart 300 in another format. For example, as will be discussed below with reference to FIG. 4C, the social media engine 260 may generate alternative comparison charts.

In FIGS. 4A-6B present embodiments illustrating the functionality of the social media marketing system 110. For example, a social media post 400 is illustrated in FIG. 4A. As described above, a computing device (e.g., a computer, a laptop), or a handheld computing device (e.g., a smartphone, a tablet, a personal digital assistant) can provide or display the social media post 400. The social media system 108 may receive the social media post 400 from one of the users 102a, 102b, 102c via one of the client devices 104a, 104b, 104c and deliver the social media post 400 to the social media marketing system 110 via the social media sentinel 210.

The social media post 400 may include various identifiers and controls in addition to the message of the post. For example, as shown in FIG. 4A, the social media post 400 may include a personal identifier 404, a media handle 408, a post date 412, and a user image, avatar, or icon 416. In one or more embodiments, a user who composed the social media post 400 may select the personal identifier 404, the media handle 408, and the user image 416. In one embodiment, the media handle 408 is a unique identifier utilized by other social media users in order to include the user associated with the media handle 408 in specific social media based discussions.

In one or more embodiments, the post date 412 can indicate when the user 102 sent the social media post 400 to the social media system 108. For example, as shown in FIG. 4A, the post date 412 may indicate the social media post 400 was submitted to the social media system 108 on “11 Nov, 30 mins ago.” In additional or alternative embodiments, the social media system 108 can display the post date 412 in other formats. For example, the social media system 108 can display the post date 412 in a format indicating only how long ago the social media post 400 was submitted (e.g., “30 minutes ago,” “yesterday”).

Additionally, the social media post 400 may include a post message 420. In one or more embodiments, the post message 420 contains text inputted by the user 102 communicating a message that user 102 wishes to share with other co-users of the social media system 108. For example, as shown in FIG. 4A, the post message 420 contains the question, “Brand X vs. Brand Y . . . which one is better?” along with a link to a web page. Accordingly, the post message 420 indicates the user associated with the personal identifier 404 and the media handle 408 is asking for recommendations from other co-users of the social media system 108.

The social media post 400 may also include controls that allow a co-user to interact with the social media post 400 in certain ways. For example, the social media post 400 may include a reply control 424, a recycle control 428, and a favorite control 432. In one or more embodiments, by interacting with the reply control 424, a co-user may reply to the social media post 400. Similarly, in one or more embodiments, by interacting with the recycle control 428, a co-user may re-post the social media post 400 such that other users associated with the co-user, but not the user associated with the personal identifier 404 and the media handle 408, may see the post message 420. Additionally, by interacting with the favorite control 432, a co-user may bookmark the social media post 400 for easy access at a later point. It will be understood that in one or more embodiments, the social media marketing system 110 may utilize these controls in order to reply to social media discussions, as well as to re-post various social media posts.

In one embodiment, a user of the social media marketing system 110 may configure the social media sentinel 210 with the keyword “Brand X.” In that case, the social media sentinel 210 may capture the social media post 400 as part of a set of relevant social media posts, as described above, since the social media post 400 mentions the keyword, “Brand X.” Accordingly, the entity extractor 220 may extract “Brand X” and “Brand Y” as entities within the social media post 400. As discussed above, the entity extractor 220 can discard the entity “Brand X” since it is the same as the keyword, and add “Brand Y” to the list of socially relevant competitors.

At this point, the theme extractor 230 may determine that the social media post 400 contains no socially relevant themes. Accordingly, in one or more embodiments, the social media engine 260 may not include the social media post 400 in the data used to build the comparison chart 300, as shown in FIG. 3. Rather, the social media marketing system 110 may determine the social media post 400 is part of a relevant social media discussion that should be targeted.

As mentioned above, in one or more embodiments, the social media marketing system 110 may target social media discussions in order to influence the discussion participants in favor of a keyword (i.e., in favor of a brand or product designated in a campaign or by a marketer). For example, the social media engine 260 may generate a social media reply in response to a targeted social media discussion. Furthermore, the social media engine 260 may utilize controls of the social media system 108 in order to post the generated social media reply. Thus, in one embodiment, the social media marketing system 110 may reply to relevant social media discussions in a variety of ways.

For instance, as discussed above, the social media engine 260 may target the social media post 400 as a relevant social media discussion and automatically generate and send a social media reply in order to influence the discussion. As shown in FIG. 4B, the social media engine 260 may generate a social media reply 440 to the post message 420 in the social media post 400. For example, the social media reply 440 may include the personal identifier 404′ of the user of the social media marketing system 110 (i.e., “Brand X”), the media handle 408′ associated with the user of the social media marketing system 110, the user image 416′ associated with the user of the social media marketing system 110, and the post date 412′ of the reply.

As mentioned above, the theme extractor 230 may determine that no theme is associated with the post message 420. Accordingly, in one or more embodiments, the social media engine 260 may generate a general positive reply, as illustrated in FIG. 4B. For example, as shown in FIG. 4B, the social media engine 260 may generate a reply message 444 including the media handle 404 associated with the post message 420 (i.e., “@JulesMd”), a standard message that is positively inclined toward “Brand X” over “Brand Y,” and a hyperlink to a website with more information.

In some embodiments, the social media system 108 may allow for reply messages of unlimited length. In other words, in some embodiments, the social media engine 260 may include more information than is included in the reply message 444. However, in some embodiments, the social media system 108 may only allow the reply message 444 to include a limited number of characters. In that case, the social media engine 260 may include a hyperlink as part of the reply message 444, as shown in FIG. 4B.

Once the social media engine 260 has generated the reply message 444 and the other information contained in the social media reply 440, the social media sentinel 210 can automatically send the social media reply. For example, as shown in FIG. 4B, the social media sentinel can package, format, and send the reply message 444 and the other information contained in the social media reply 440 such that it matches the format of the original social media post 400, shown in FIG. 4A. Thus, from a user's perspective, the social media marketing system 110 can send automatic replies to social media posts that fit seamlessly into existing social media discussions without any input from a user.

In one or more embodiments, the user associated with the post message 420 may access further information about “Brand X” by clicking on the hyperlink included in the reply message 444. For example, as shown in FIG. 4C, the hyperlink may direct the user associated with the post message 420 (or any other co-user viewing the social media discussion) to a web browser 410 displaying a web page. In one or more embodiments, the web page may display information from the comparison chart 300 as described with reference to FIG. 3.

In one embodiment, the social media marketing system 110 may provide the comparison chart 300 in response to any identified social media post that mentions the keyword and/or a competitor, but from which the theme extractor 230 extracts no theme. For example, the post message 420 of FIG. 4A refers to “Brand X” and “Brand Y” but includes no themes. Accordingly, rather than generating a reply message 444 that mentions a theme (i.e., “tests”), as shown in FIG. 4B, the social media marketing system 110 may simply provide the comparison chart 300 in the reply post 440. Thus, in that case, the user may see a custom feature-by-feature comparison including those features that are most actively discussed in current social media discussions. In some embodiments, the social media marketing system 110 may not be able to include the comparison chart 300 in a reply message, so rather the social media marketing system 110 may include a link in the reply message 444, as shown in FIG. 4B, that directs a user to a web page displaying the comparison chart 300.

As illustrated in FIG. 4C, the comparison chart 300′ may display information from the comparison chart 300 in a different format or configuration. For example, while the social media engine 260 may include only numerical data in the comparison chart 300, as shown in FIG. 3, the social media engine 260 may create alternate formats of the comparison chart 300 where the numerical data is presented in a manner that may be easier for an average user to understand. For instance, the comparison chart 300′, as shown in FIG. 4C, presents the numerical data as a bar chart, wherein the relationship between competitor #1 of column 302a and theme #1 of row 304a in FIG. 3 is represented by a bar, rather than a number as in cell 306a of FIG. 3. In additional or alternative embodiments, the social media engine 260 may present the numerical data in a pie chart, a line graph, or any other suitable format. Additionally, the social media engine 260 may also provide extra explanation or summary as to what the comparison chart 300′ means with regard to “Brand X” and “Brand Y.”

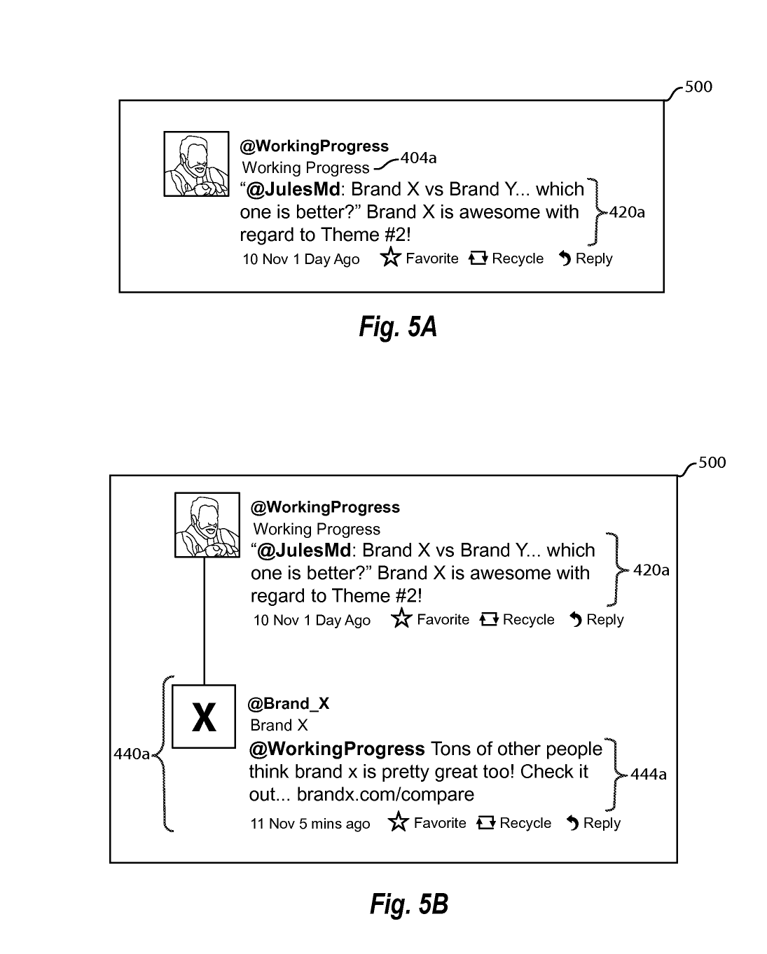

As mentioned above, an embodiment described herein also identifies social media posts that are positively inclined toward a given keyword with respect to a certain theme. For example, as illustrated in FIG. 5A, a social media post 500 may include a post message 420a responding to the question posed in the post message 420 in FIG. 4A. As shown, the user associated with the personal identifier 404a responds to the post message 420 of FIG. 4A with the statement, “Brand X is awesome with regard to Theme #2!”

In one or more embodiments, as described above, the social media sentinel 210 may capture the social media post 500 as illustrated in FIG. 5A because the post message 420a is associated with both the keyword (i.e., “Brand X”) and a socially relevant competitor of the keyword (i.e., “Brand Y”). Accordingly, in one or more embodiments, the social media engine 260 may target the social media post 500 as a socially relevant discussion. Once the social media sentinel 210 has captured the social media post 500, the theme extractor 230 may extract “Theme #2” from the social media post 500. Thus, at this point, the social media engine 260 has determined the social media post 500 compares the keyword, “Brand X,” and the socially relevant competitor, “Brand Y,” based on the theme, “Theme #2.”

Next, in one or more embodiments, the social media engine 260 may direct the sentiment analyzer 240 to determine whether the social media post 500 is positively or negatively inclined toward the keyword with regard to the theme. For example, as described above, the sentiment analyzer 240 may parse the post message 420a to determine the post message 420a including, “Brand X is awesome with regard to Theme #2,” is positively inclined toward the keyword (i.e., “Brand X”) with regard to “Theme #2.” Accordingly, the sentiment analyzer 240 may store the social media post 500 in the data storage 280 such that the social media post 500 is associated with the theme, “Theme #2,” within the comparison data 282.

Furthermore, the social media engine 260 may automatically send a reply to the social media post 500 in order to bolster the positive sentiment expressed therein. For example, as illustrated in FIG. 5B, the social media engine 260 may generate a reply message 440a in response to the post message 420a and automatically send the reply message 440a to the social media system 108 via the social media sentinel 210. In one or more embodiments, the social media engine 260 may generate the reply message 444a within reply post 440a that includes a general message to bolster the sentiment expressed in the post message 420a (i.e., “Tons of other people thing Brand X is pretty great too!”), as well as a hyperlink directing a user 102 to a webpage, such as the webpage 448 illustrated in FIG. 4C.

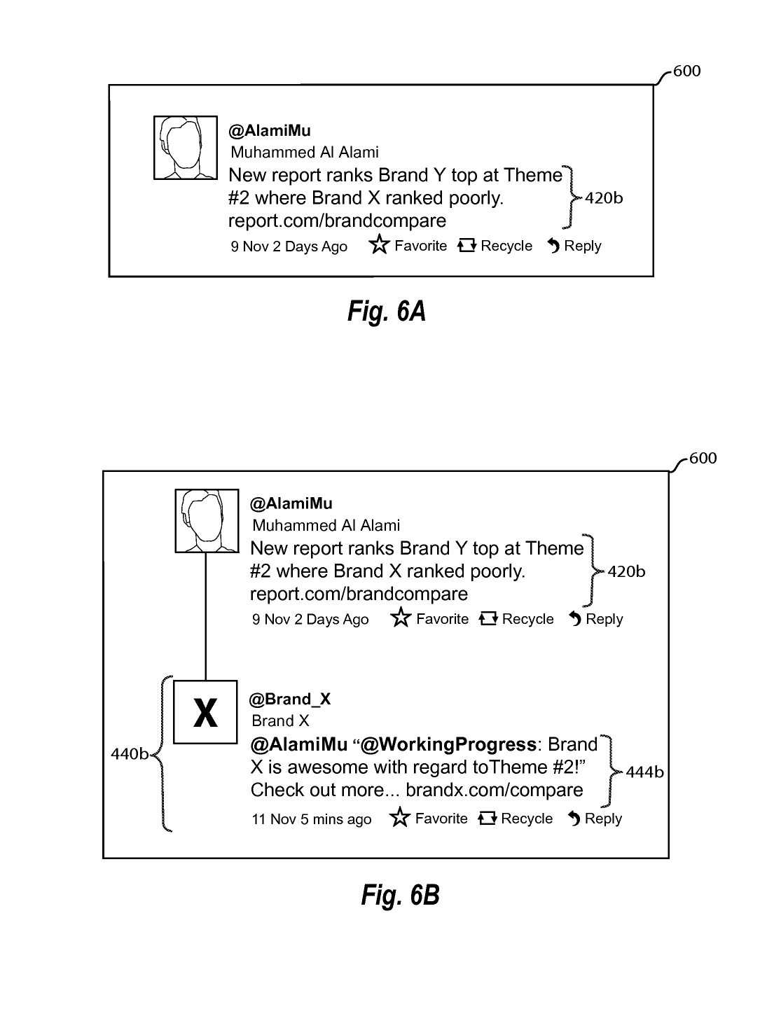

In addition to the embodiments, described above with regard to FIGS. 4A and 5A, the social media marketing system 110 may also identify and target social media posts that are negatively inclined toward the keyword. For example, as illustrated in FIG. 6A, a social media post 600 may include a post message 420b stating, “New report ranks Brand Y top at Theme #2 where Brand X ranked poorly.” As described above, the social media marketing system 110 may identify the social media post 600 as a relevant social media post since it mentions both the keyword “Brand X,” and a socially relevant competitor, “Brand Y.” Next, in one or more embodiments, the social media engine 260 may direct the theme extractor 230 to extract the relevant theme (i.e., “Theme #2”) and the sentiment analyzer 240 to determine whether the post message 420b is positively or negatively inclined toward the keyword with regard to the relevant theme.

In response to the sentiment analyzer 240 determining the post message 420b is negatively inclined toward the keyword with regard to the relevant theme, the social media engine 260 may generate a reply in an attempt to counteract the negative sentiment expressed in the post message 420b. As described above with reference to FIG. 5A, the sentiment analyzer 240 may store a positively inclined social media post in the data storage 280 such that the stored social media post is associated with a relevant theme mentioned therein. Accordingly, the social media engine 260 may utilize one or more stored social media posts that are positively inclined toward the keyword in generating a reply to the post message 420b.

For example, as shown in FIG. 6B, the social media engine 260 may generate a reply post 440b with a reply message 444b including the sentiment of the post message 420a that is positively inclined toward the keyword with regard the same theme mentioned in the post message 420b. In one or more embodiments, the social media engine 260 may retrieve the post message 420a by querying the data storage 280 for social media posts related to “Theme #2.” In response to the query, the social media engine 260 may receive all the social media posts stored in data storage 280 that are positively inclined toward the keyword with regard to “Theme #2.” Alternatively or additionally, in response to the query, the social media engine 260 may only receive the most recent positively inclined social media post, a subset of positively inclined social media posts that are strongly positively inclined, or only phrases or portions of messages that are specific to the relevant theme (i.e., the reply message 444b only includes the portion “Brand X is awesome with regard to Theme #2” of the post message 420a).

Once the social media engine 260 receives at least one positively inclined social media post (i.e., post message 420a), the social media engine 260 may generate the reply message 444b including the at least one positively inclined social media post, and automatically send the reply message 444b to the social media system 108 via the social media sentinel 210. Additionally, the social media engine 260 may include a hyperlink directing a user 102 to a webpage, such as the webpage 448 shown in FIG. 4C. In one or more alternative embodiments, the social media engine 260 may generate the reply message 444b to include one or more of all positively inclined social media posts received from the data storage 280, a summary of all positively inclined social media posts, or a generic positive statement related to the keyword and the relevant theme.

In one embodiment, the social media engine 260 may only generate replies to negatively inclined social media posts, if the social media engine 260 determines the competitor mentioned in the negatively inclined social media post meets a threshold level of relevancy. For example, as described above with reference to FIG. 3, some competitors are compared more frequently in social media posts to a keyword (as indicated by the relevancy scores 308a-308d). Thus, the social media engine may only generate replies to social media posts including the most frequently mentioned competitors. In one embodiment, “Brand Y,” mentioned in the post message 420a is one of the most relevant competitors of “Brand X.” Accordingly, the social media engine 260 may generate the reply message 444b.

Additionally or alternatively, it is possible that the social media engine 260 may not be able to find any positively inclined social media posts in the data storage 280 that are associated with the theme mentioned in the post message 420b. In that case, the social media engine 260 may generate a reply that mitigates the negative sentiment in the post message 420b. For example, the social media engine 260 may generate a post that gives specific data related to the theme extracted from the post message 420b (e.g., “In the new report Brand X was only two places behind Brand Y with regard to Theme #2”). Alternatively, the social media engine 260 may generate a post that directs the social media discussion to a theme where the keyword performs more strongly (e.g., “In national tests, customers value Theme #1 most highly, and a recent report ranks Brand X highly with regard to Theme #1). Thus, the social media engine 260 may influence negative sentiments, even when the negative sentiments are factually based.

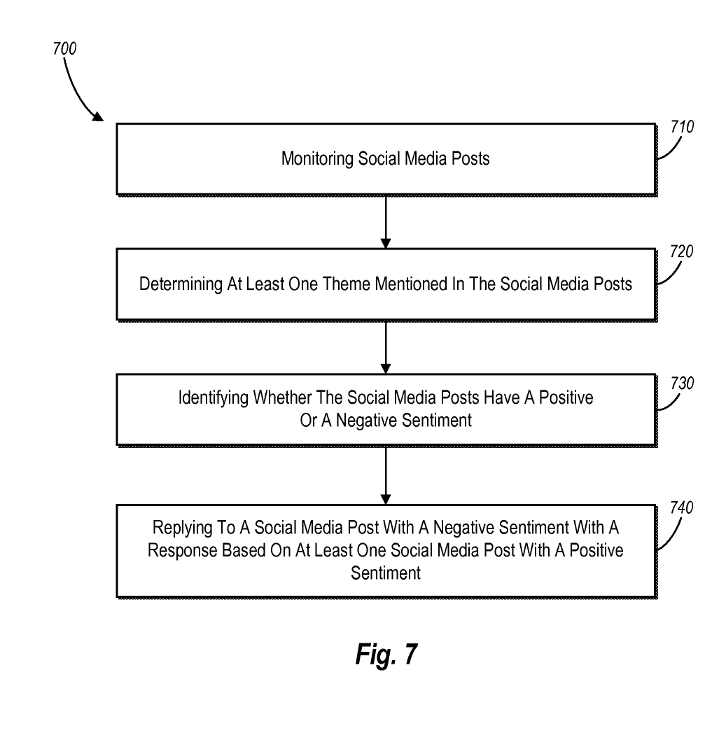

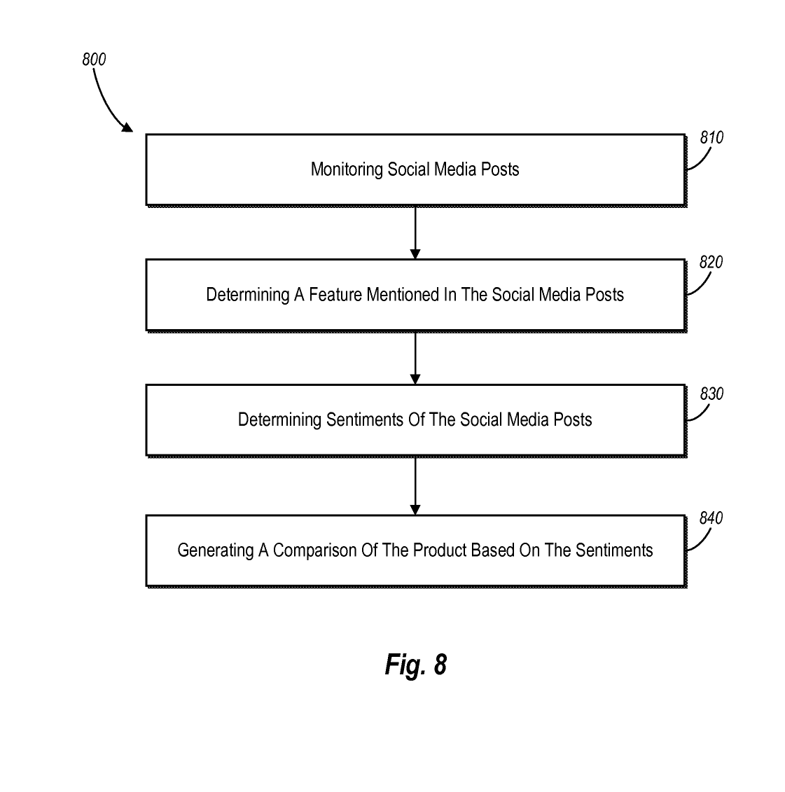

FIGS. 1-6B, the corresponding text, and the examples, provide a number of different systems and devices for leveraging social media. In addition to the foregoing, embodiments of the present invention can also be described in terms of flowcharts comprising acts and steps in a method for accomplishing a particular result. For example, FIGS. 7 and 8 illustrate flowcharts of exemplary methods in accordance with one or more embodiments of the present invention. The methods described in relation to FIGS. 7 and 8 may be performed with less or more steps/acts or the steps/acts may be performed in differing orders. Additionally, the steps/acts described herein may be repeated or performed in parallel with one another or in parallel with different instances of the same or similar steps/acts.

FIG. 7 illustrates a flowchart of one example method 700 of leveraging social media. The method 700 includes an act 710 of monitoring social media posts 400, 500, 600. In particular, the act 710 can involve monitoring a plurality of social media posts 400, 500, 600 for reference to one or more keywords related to a product.

The method 700 can further include an act 720 of determining at least one theme (e.g., as in those related to rows 304a-304f of FIG. 3) mentioned in the social media posts 400, 500, 600. In particular, the act 720 can involve determining at least one theme related to the product mentioned in the plurality of social media posts 400, 500, 600. In one or more embodiments, determining at least one theme related to the product mentioned in the plurality of social media posts 400, 500, 600 may further include extracting phrases from the plurality of social media posts 400, 500, 600, and identifying the at least one theme from the extracted phrases.

Additionally, the method 700 may further include an act 730 of identifying whether the social media posts 400, 500, 600 have a positive or a negative sentiment. In particular, the act 730 can involve identifying whether the plurality of social media posts 400, 500, 600 have a positive or a negative sentiment with respect to the at least one theme related to the product. In one or more embodiments, identifying whether the plurality of social media posts 400, 500, 600 have a positive or a negative sentiment can include analyzing the plurality of social media posts 400, 500, 600 for positive or negative sentiments at a phrase level, or analyzing the plurality of social media posts 400, 500, 600 for positive or negative sentiments at a document level.

Furthermore, the method 700 can include an act 740 of replying to a social media post with a negative sentiment (i.e., the social media post 600). In particular, the act 740 can involve, upon identifying a social media post having a negative sentiment with respect to the at least one theme related to the product, replying to the social media post having a negative sentiment with a response based on at least one social media post from the plurality of social media posts having a positive sentiment with respect to the at least one theme related to the product (i.e., as in the reply post 440b in FIG. 6B). In one or more embodiments, replying to the social media post having a negative sentiment with a response based on at least one social media post from the plurality of social media posts having a positive sentiment can include posting at least one social media post from the plurality of social media posts having the positive sentiment as a reply to the social media post having the negative sentiment (i.e., as in the reply message 444b in FIG. 6B). In one embodiment, replying to the social media post having a negative sentiment with a response based on at least one social media post from the plurality of social media posts having a positive sentiment with respect to the at least one theme related to the product is performed automatically and without human interaction. Additionally, act 740 can involve identifying a social media post having a positive sentiment with respect to the at least one theme, replying to the social media post having a positive sentiment with a response based on at least one social media post from the plurality of social media posts having a negative sentiment with respect to the at least one theme.

The method 700 may further include a step of generating a table containing socially relevant competitors and how the product is being compared to products of the socially relevant competitors on social media (e.g., comparison chart 300 of FIG. 3). In one or more embodiments, the step of generating the table may further include identifying a subset of the plurality of social media posts 400, 500, 600, referencing the one or more keywords, extracting one or more entities from the subset of the plurality of social media posts, determining whether the one or more extracted entities are associated with the product. In an embodiment, if the extracted entity is associated with the product, the method 700 may disregard the extracted entity, and if the extracted entity is not associated with the product, the method 700 may modify the table.

In one or more embodiments, the step of generating a table can further involve determining if the extracted entity exists in the table, and if the extracted entity does not exist in the table, adding the extracted entity to the table. If the extracted entity exists in the table, the method 700 may include incrementing a count (i.e., as in the counts associated with the relevancy scores 308a-308d of FIG. 3) associated with the entity, wherein the count associated with the entity indicates how socially relevant the entity is as a competitor. Furthermore, the method 700 may also include modifying the table by incrementing a count associated with the theme and a competitor connected to the social media post, if the social media post is identified as having a positive sentiment with respect to the theme (e.g., as indicated by the count in cell 306b in FIG. 3). If the social media post is identified as having a negative sentiment with respect to the theme, the method 700 can involve modifying the table by decrementing a count (e.g., as indicated by the count in cell 306a in FIG. 3) associated with the theme and the competitor connected to the social media post. Additionally, in one or more embodiments, the method 700 can include replying to the social media post, wherein replying to the social media post having a negative sentiment with a response based on at least one social media post from the plurality of social media posts having a positive sentiment includes providing access to the table in reply to the social media post having the negative sentiment (e.g., as in the web page 448 in FIG. 4C). In one embodiment, providing access to the table in reply to the social media post having the negative sentiment is performed automatically and without human interaction.

FIG. 8 illustrates a flowchart of another example method 800 of leveraging social media. The method 800 includes an act 810 of monitoring social media posts 400, 500, 600. In particular, the act 810 can involve monitoring a plurality of social media posts 400, 500, 600 related to a product and at least one competing product.

The method 800 can further include an act 820 of determining a feature mentioned in the social media posts. In particular, the act 820 can involve determining features of the product or the at least one competing product mentioned in the plurality of social media posts. In one or more embodiments, determining features of the product or the at least one competing product can involve identifying themes mentioned in the plurality of social media posts.

The method 800 can also include an act 830 of determining sentiments of the social media posts. In particular, the act 830 can involve determining sentiments of the plurality of social media posts with regard to the determined features. In one or more embodiments, determining sentiments of the plurality of social media posts with regard to the determined features can involve determining if a social media post of the plurality of social media posts 400, 500, 600 is positively inclined toward the product based on a feature, or if the social media post of the plurality of social media posts is negatively inclined toward the product based on the feature.

Additionally, the method 800 can include an act 840 of generating a comparison (e.g., comparison chart 300 of FIG. 3) of the product based on the sentiments. In particular, the act 840 can involve generating a comparison of the product and the at least one competing product based on the sentiments of the social media posts with regard to the features. In one or more embodiments, generating a comparison of the product and the at least one competing product based on the sentiments of the social media posts can involve scoring features of the product relative to features of a competing product based on the sentiments of the social media posts. Additionally, the method 800 can further include a step of providing a positive count (e.g., as in cells 306b, 306c, 306d, and 306f in FIG. 3) associated with a feature and a competing product if a majority of social media posts favor the product over the competing product with respect to the feature, and providing a negative count (e.g., as in cells 306a and 306e in FIG. 3) associated with the feature and the competing product if a majority of social media posts favor the competing product over the product with respect to the feature. In one or more embodiments, generating a comparison of the product and the at least on competing product based on the sentiments of the social media posts with regard to the features is performed automatically and without human interaction.

The method 800 can also include steps of identifying a social media post from the plurality of social media posts negatively inclined toward the product with respect to the feature, and providing a reply to the social media post comprising one or more social media posts form the plurality of social media posts positively inclined towards the product with respect to the feature (e.g., as in FIG. 6B). Additionally or alternatively, the method 800 can include steps of identifying a social media post from the plurality of social media posts mentioning the at least one competing product and negatively inclined toward the product based on the feature, determining how relevant the at least one competing product is with regard to the product, and if the at least one competing product is determined to be relevant to the product, providing a reply to the social media post comprising one or more social media posts from the plurality of social media posts positively inclined towards the product with respect to the feature. Additionally or alternatively, the method 800 can include the steps of identifying a social media post from the plurality of social media posts 400, 500, 600 mentioning features of the product or the at least one competing product and negatively inclined toward the product based on the feature of the product or the at least one competing product, and providing a reply to the social media post comprising one or more social media posts from the plurality of social media posts positively inclined toward the product with respect to the feature.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general purpose computer to turn the general purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of an exemplary computing device 900 that may be configured to perform one or more of the processes described above. One will appreciate that the display mirroring system 100 may be implemented by one or more computing devices such as the computing device 900. In particular, any of the client device 204, 300, the server 210, and the display device 206, 302 can comprise a computing device 900. As shown by FIG. 9, the computing device 900 can comprise a processor 902, memory 904, a storage device 906, an I/O interface 908, and a communication interface 910, which may be communicatively coupled by way of a communication infrastructure 912. While an exemplary computing device 900 is shown in FIG. 9, the components illustrated in FIG. 9 are not intended to be limiting. Additional or alternative components may be used in other embodiments. Furthermore, in certain embodiments, the computing device 900 can include fewer components than those shown in FIG. 9. Components of the computing device 900 shown in FIG. 9 will now be described in additional detail.

In particular embodiments, the processor 902 includes hardware for executing instructions, such as those making up a computer program. As an example and not by way of limitation, to execute instructions, the processor 902 may retrieve (or fetch) the instructions from an internal register, an internal cache, the memory 904, or the storage device 906 and decode and execute them. In particular embodiments, the processor 902 may include one or more internal caches for data, instructions, or addresses. As an example and not by way of limitation, the processor 902 may include one or more instruction caches, one or more data caches, and one or more translation lookaside buffers (TLBs). Instructions in the instruction caches may be copies of instructions in the memory 904 or the storage 906.

The memory 904 may be used for storing data, metadata, and programs for execution by the processor(s). The memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 may be internal or distributed memory.

The storage device 906 includes storage for storing data or instructions. As an example and not by way of limitation, the storage device 906 can comprise a non-transitory storage medium described above. The storage device 906 may include a hard disk drive (HDD), a floppy disk drive, flash memory, an optical disc, a magneto-optical disc, magnetic tape, or a Universal Serial Bus (USB) drive or a combination of two or more of these. The storage device 906 may include removable or non-removable (or fixed) media, where appropriate. The storage device 906 may be internal or external to the computing device 900. In particular embodiments, the storage device 906 is non-volatile, solid-state memory. In other embodiments, the storage device 906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 908 allows a user to provide input to, receive output from, and otherwise transfer data to and receive data from the computing device 900. The I/O interface 908 may include a mouse, a keypad or a keyboard, a touch screen, a camera, an optical scanner, network interface, modem, other known I/O devices or a combination of such I/O interfaces. The I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 908 is configured to provide graphical data to a display for presentation to a user. The graphical data may be representative of one or more graphical user interfaces and/or any other graphical content as may serve a particular implementation.

The communication interface 910 can include hardware, software, or both. In any event, the communication interface 910 can provide one or more interfaces for communication (such as, for example, packet-based communication) between the computing device 900 and one or more other computing devices or networks. As an example and not by way of limitation, the communication interface 910 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 912 may include hardware, software, or both that couples components of the computing device 900 to each other. As an example and not by way of limitation, the communication infrastructure 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method for replying to social media postings as part of a marketing campaign comprising:
monitoring, by a computing device comprising at least one processor, a plurality of social media posts for reference to one or more keywords related to a brand;
determining, by the computing device, at least one theme related to the brand mentioned in the plurality of social media posts;
identifying, by the computing device, whether the plurality of social media posts have a positive or a negative sentiment with respect to the at least one theme; and
upon identifying a social media post having a negative sentiment with respect to the at least one theme related, replying to the social media post having a negative sentiment with a response based on at least one social media post from the plurality of social media posts having a positive sentiment with respect to the at least one theme.

2. The method as recited in claim 1, further comprising generating a table containing socially relevant competitors and how the brand is being compared to the socially relevant competitors on social media.

3. The method as recited in claim 2, further comprising:
identifying a subset of the plurality of social media posts referencing the one or more keywords;
extracting one or more entities from the subset of the plurality of social media posts;
determining whether the one or more extracted entities are associated with the brand;
if an extracted entity is associated with the brand, disregarding the extracted entity;
if the extracted entity is not associated with the product, modifying the table.

4. The method as recited in claim 3, further comprising:
determining if the extracted entity exists in the table;
if the extracted entity does not exist in the table, adding the extracted entity to the table as a socially relevant competitor;
if the extracted entity exists in the table, incrementing a count associated with the entity, wherein the count associated with the entity indicates how socially relevant the entity is as a competitor.

5. The method as recited in claim 1, wherein determining at least one theme related to the brand mentioned in the plurality of social media posts comprises:
extracting phrases from the plurality of social media posts;
identifying the at least one theme from the extracted phrases.

6. The method as recited in claim 2, wherein identifying whether the plurality of social media posts have a positive or a negative sentiment comprises:
analyzing the plurality of social media posts for positive or negative sentiments at a phrase level, or
analyzing the plurality of social media posts for positive or negative sentiments at a document level.

7. The method as recited in claim 6, further comprising:
if a social media post is identified as having a positive sentiment with respect to a theme, modifying the table by incrementing a count associated with the theme and a competitor connected to the social media post;
if the social media post is identified as having a negative sentiment with respect to the theme, modifying the table by decrementing a count associated with the theme and the competitor connected to the social media post.

8. The method as recited in claim 7, wherein replying to the social media post having a negative sentiment with a response based on at least one social media post from the plurality of social media posts having a positive sentiment comprises posting at least one social media post from the plurality of social media posts having the positive sentiment as a reply to the social media post having the negative sentiment.

9. The method as recited in claim 8, wherein replying to the social media post having a negative sentiment with a response based on at least one social media post from the plurality of social media posts having a positive sentiment comprises providing access to the table in reply to the social media post having the negative sentiment.

10. A method of analyzing social medias for consumer ratings, comprising:
monitoring, by a computing device comprising at least one processor, a plurality of social media posts related to a product and at least one competing product;
determining, by the at least one processor, features of the product or the at least one competing product mentioned in the plurality of social media posts;
determining, by the at least one processor, sentiments of the plurality of social media posts with regard to the determined features; and
generating, by the at least one processor, a comparison of the product and the at least one competing product based on the sentiments of the social media posts with regard to the features.

11. The method as recited in claim 10, wherein determining sentiments of the plurality of social media posts with regard to the determined features comprises determining if a social media post of the plurality of social media posts is positively inclined toward the product based on a feature, or if the social media post of the plurality of social media posts is negatively inclined toward the product based on the feature.

12. The method as recited in claim 11, wherein generating a comparison of the product and the at least one competing product based on the sentiments of the social media posts comprises scoring features of the product relative to features of a competing product based on the sentiments of the social media posts.

13. The method as recited in claim 12, further comprising providing a positive count associated with a feature and a competing product if a majority of social media posts favor the product over the completing product with respect to the feature providing a negative count associated with the feature and the competing product if a majority of social media posts favor the competing product over the product with respect to the feature.

14. The method as recited in claim 11, further comprising:
identifying a social media post from the plurality of social media posts negatively inclined toward the product with respect to the feature;
providing a reply to the social media post comprising one or more social media posts from the plurality of social media posts positively inclined towards the product with respect to the feature.

15. The method as recited in claim 11, further comprising:
identifying a social media post from the plurality of social media posts mentioning the at least one competing product and negatively inclined toward the product based on the feature;
determining, by the computing device, how relevant the at least one competing product is with regard to the product;
if the at least one competing product is determined to be relevant to the product, providing a reply to the social media post comprising one or more social media posts from the plurality of social media posts positively inclined towards the product with respect to the feature.

16. The method as recited in claim 11, further comprising:
identifying a social media post from the plurality of social media posts mentioning features of the product or the at least one competing product and negatively inclined toward the product based on the features of the product or the at least one competing product;
providing a reply to the social media post comprising one or more social media posts from the plurality of social media posts positively inclined toward the product with respect to the feature.

17. A system comprising:
at least one processor; and
at least one non-transitory computer-readable storage medium storing instructions thereon that, when executed by the at least one processor, cause the system to:
monitor a plurality of social media posts for reference to one or more keywords related to a product;
determine at least one theme related to the product mentioned in the plurality of social media posts;
identify whether the plurality of social media posts have a positive or a negative sentiment with respect to the at least one theme related to the product; and
upon identifying a social media post having a negative sentiment with respect to the at least one theme related to the product, reply to the social media post having a negative sentiment with a response based on at least one social media post from the plurality of social media posts having a positive sentiment with respect to the at least one theme related to the product.

18. The system as recited in claim 17, further comprising instructions that when executed by the at least one processor, cause the system to:
generate a table containing socially relevant competitors and how the product is being compared to products of the socially relevant competitors on social media;
identify a subset of the plurality of social media posts referencing the one or more keywords;
extract one or more entities from the subset of the plurality of social media posts;
determine whether the one or more extracted entities are associated with the product;
if an extracted entity is associated with the product, disregard the extracted entity;
if the extracted entity is not associated with the product, modify the table.

19. The system as recited in claim 18, further comprising instructions that when executed by the at least one processor, cause the system to:
analyze the plurality of social media posts for positive or negative sentiments;
if a social media post is identified as having a positive sentiment with respect to a theme, modify the table by incrementing a count associated with the theme and a competitor connected to the social media post;
if the social media post is identified as having a negative sentiment with respect to the theme, modify the table by decrementing a count associated with the theme and the competitor connected to the social media post.

20. The system as recited in claim 19, wherein replying to the social media post having a negative sentiment with a response based on at least one social media post from the plurality of social media posts having a positive sentiment comprises posting at least one social media post from the plurality of social media posts having the positive sentiment as a reply to the social media post having the negative sentiment.
